(19) United States
(12) Patent Application Publication
(10) Pub. No.: US 2025/0138277 A1
(43) Pub. Date: May 1, 2025

(54) OPTICAL APPARATUS AND IMAGING APPARATUS

(71) Applicant: CANON KABUSHIKI KAISHA, Tokyo (JP)

(72) Inventor: KEIKI OIKAWA, Tochigi (JP)

(21) Appl. No.: 18/926,484

(22) Filed: Oct. 25, 2024

(30) Foreign Application Priority Data
Oct. 31, 2023 (JP) 2023-186883

(51) Int. Cl. G02B 7/10

(52) U.S. Cl. CPC G02B 7/10

(57) ABSTRACT

An interchangeable lens comprises a guide barrel, a rear base that moves in an optical axis direction, a cam ring rotatably held with respect to the guide barrel, and a zoom position detection scale and a zoom position detection sensor configured to directly detect a relative position between the rear base and the guide barrel. The rear base holds a fourth main bearing that engages with one of a rear rectilinear groove and a cam groove provided in the guide barrel and one of a rear cam groove and a rectilinear groove provided in the cam ring. The rear base moves in the optical axis direction by rotation of the cam ring.

### BACKGROUND

### Technical Field

The present disclosure relates to an optical apparatus and an imaging apparatus.

### Description of the Related Art

In a camera system, in order to suppress focus movement that occurs when the focal length is changed by a mechanical mechanism, control is performed such that the focus lens is moved in accordance with a change in the zoom position to correct the focus movement and maintain the in-focus state. A movement locus of the focus lens is determined in advance as an electronic cam locus (tracking data) indicating the position of the focus lens with respect to the position of the moving lens unit for each object distance. In such a zoom optical system, in order to perform zooming while maintaining an in-focus state, it is necessary to always accurately hold the position of the moving lens unit and the position of the focus lens so as to have a relationship determined by tracking data.

Japanese Patent Application Laid-Open No. 2014-186225 discloses a configuration in which the rotational position of a cam barrel that rotates integrally with a zoom ring is detected by a linear position sensor to detect the rotational position of the zoom ring. Further, Japanese Patent Application Laid-Open No. 2017-122755 discloses a configuration in which an engagement member of a linear sensor is engaged with an engagement groove formed in an assist ring, and a zoom position of a second lens unit radially fitted to the assist ring is detected by the linear sensor.

### SUMMARY

An object of the present disclosure is to provide an optical apparatus capable of suppressing a focus movement caused by a zoom change during a zoom reversal operation.

According to an embodiment of the present invention, an optical apparatus comprising: a fixed member, a base moving member that moves in an optical axis direction, a rotating member rotatably held with respect to the fixed member, and a detection unit configured to directly detects a relative position between the base moving member and the fixed member, wherein the base moving member holds an engaging member that engages with one of a rectilinear groove and a cam groove provided in the fixed member and one of a cam groove and a rectilinear groove provided in the rotating member, and wherein the base moving member moves in the optical axis direction by rotation of the rotating member.

Further features of the present disclosure will become apparent from the following description of exemplary embodiments with reference to the attached drawings.

### BRIEF DESCRIPTION OF THE DRAWINGS

FIG. 1 is a cross-sectional view of an interchangeable lens (1) at a wide angle end (wide end) and a telephoto end (tele end).

FIG. 2 is an exploded perspective view of the outer casing and the guide barrel unit.

FIG. 3 is an exploded perspective view of the guide barrel unit.

FIG. 4 is an exploded perspective view of each lens unit constituting the zoom mechanism.

FIG. 5 is an exploded perspective view of a rear lens unit (800).

FIG. 6 is an exploded perspective view of the flexible substrate holder unit (410).

FIG. 7 is a perspective view of the flexible substrate holder unit (410).

FIG. 8 is a top view of the rear lens unit (800).

FIG. 9 is a side view of the rear lens unit (800).

FIG. 10 is a diagram illustrating an output characteristic of the zoom position detection sensor (16).

FIG. 11 is a schematic diagram illustrating a configuration example of an imaging apparatus.

### DESCRIPTION OF THE EMBODIMENTS

Preferred embodiments of the present invention will now be described in detail in accordance with the accompanying drawings. First, an overall configuration of an interchangeable lens 1 (optical apparatus), which is a lens barrel for a lens interchangeable camera, according to an embodiment of the present disclosure will be described with reference to the drawings.

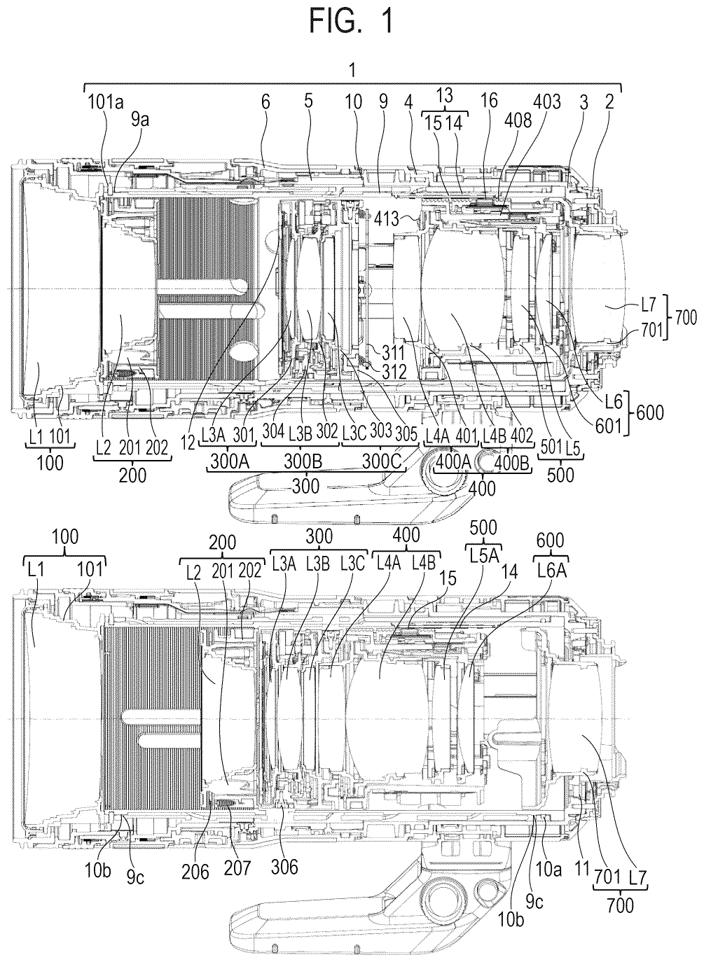

FIG. 1 is a cross-sectional view taken along a cross-section parallel to an optical axis of an interchangeable lens 1 according to the embodiment, and the drawing on the upper side of the paper surface illustrates a state at a wide angle end (wide end), and the drawing on the lower side of the paper surface illustrates a state at a telephoto end (tele end).

The interchangeable lens 1 of the embodiment is a zoom lens capable of varying a focal length from a wide angle end (wide end) to a telephoto end (tele end). A mount 2 that holds the interchangeable lens 1 so as to be electrically connectable to the camera side is attached to the interchangeable lens 1, and the interchangeable lens 1 is attachable to and detachable from the camera.

The interchangeable lens 1 has seven units configuration including lens units of a first unit to a seventh unit. These lens units are arranged in the order of a first lens unit 100, a second lens unit 200, a third lens unit 300, a fourth lens unit 400, a fifth lens unit 500, a sixth lens unit 600, and a seventh lens unit 700 from the object side. Among these lens units, the focal length can be changed from a wide angle end (wide end) to a telephoto end (tele end) by moving of the second the lens unit to the seventh the lens unit by a zoom operation.

### (About Zoom Mechanism)

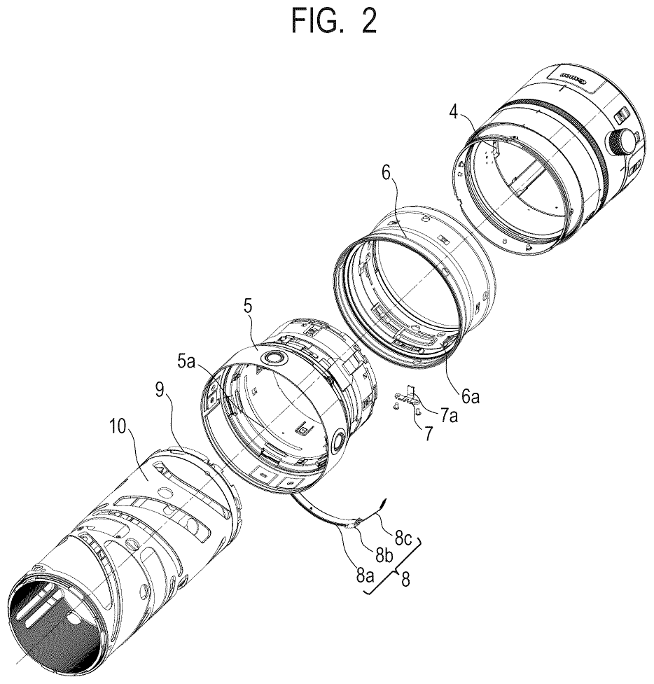

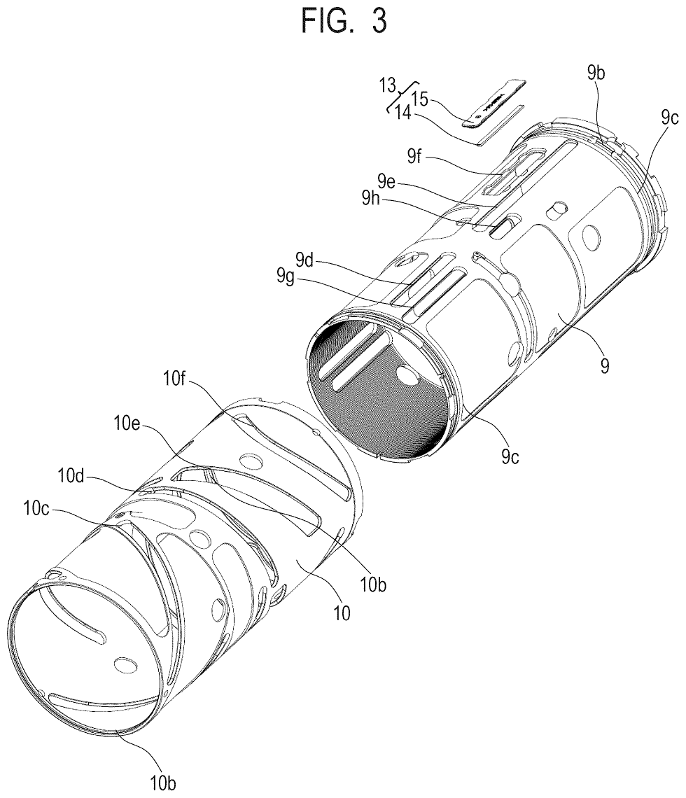

The zoom mechanism of the interchangeable lens 1 of the embodiment is a zoom mechanism using a so-called cam groove or rectilinear groove and an engagement member such as a roller or a bearing that holds each lens unit. Details of the zoom mechanism will be described with reference to FIGS. 1, 2, and 3. FIG. 2 is an exploded perspective view of the outer casing and a guide barrel unit. FIG. 3 is an exploded perspective view of the guide barrel unit.

The first fixed barrel 3 is a member that fixes and holds the mount 2, a guide barrel 9 (fixed member), and a second fixed barrel 4.

The guide barrel 9 is provided with a cam ring bayonet projection 9b that restricts the movement of a cam ring 10 (rotating member) in the optical axis direction, and the cam ring bayonet projection 9b engages with a bayonet groove 10a provided in the cam ring 10. Further, the guide barrel 9 is provided with a cam ring radial fitting portion 9c for holding the cam ring 10 rotatably around the shaft, and the cam ring radial fitting portion 9c is fitted to a guide barrel radial fitting portion 10b provided on the cam ring 10. With this configuration, the cam ring 10 is rotatably held with respect to the guide barrel 9. A guide barrel unit includes the guide barrel 9 and the cam ring 10.

Further, the guide barrel 9 is provided with a scale holding portion 9f for zoom position detection, and a scale holder unit 13 for zoom position detection is adhesively fixed to the scale holding portion 9f. The scale holder unit 13 includes a scale holder 15 for zoom position detection, and a zoom position detection scale 14 (detection unit) is adhesively fixed to the scale holder 15. A reflection pattern is provided on a surface of the zoom position detection scale 14, and when combined with a zoom position detection sensor 16 (detection unit, detection section) equipped with a light emitting portion and a light receiving portion, an absolute position can be detected by detecting the reflection pattern. Note that the zoom position detection sensor 16 may detect the zoom position detection scale 14 electrically, magnetically, or optically. The zoom position detection scale 14 is held by the guide barrel 9, and the zoom position detection sensor 16 is held by a rear base 403 (base moving member) to be described later, so that the zoom position detection sensor 16 directly detects a relative position between the rear base 403 and the cam ring 10. Alternatively, the zoom position detection scale 14 may be held by the rear base 403, and the zoom position detection sensor 16 may be held by the guide barrel 9. A method of holding the zoom position detection sensor 16 will be described later.

### (Zoom Ring Arrangement)

A zoom ring 6 is rotatably held with respect to the second fixed barrel 4. Further, a zoom key 7 is held by the zoom ring 6. The zoom key 7 passes through a zoom key slit portion 5a provided on a third fixed barrel 5 held by the second fixed barrel 4, and a cam ring engaging portion 7a provided on the zoom key 7 is engages with a zoom key engaging portion (not illustrated) provided on the cam ring 10. With this configuration, when the zoom ring 6 is rotated, the cam ring 10 rotates around the guide barrel 9 in conjunction with the rotation of the zoom ring 6.

The third fixed barrel 5 holds a rotation detection sensor 8 serving as a detector for detecting the amount of rotation of the zoom ring 6. The rotation detection sensor 8 electrically detects the amount of movement of a movable element 8b that holds a metal brush as the movable element 8b moves with respect to a resistor provided on the surface of an arc-shaped sensor base 8a.

The movable element 8b is held by a movable element holding portion 6a provided on the radially inner side of the zoom ring 6 and detects the amount of rotation of the zoom ring 6. The detected amount of rotation of the zoom ring 6 is transmitted to a main substrate 11 via a flexible printed substrate (not illustrated) to which a rotation detection sensor flexible substrate 8c is connected. The exterior is formed by assembling the second fixed barrel 4, the third fixed barrel 5, and the zoom ring 6 to the guide barrel unit.

### (About Each Lens Unit)

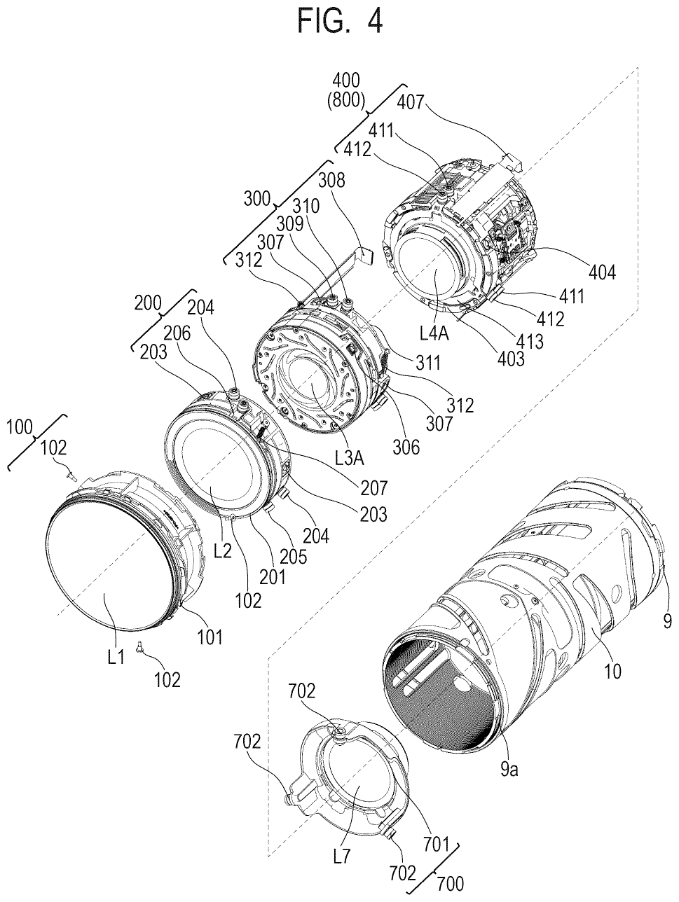

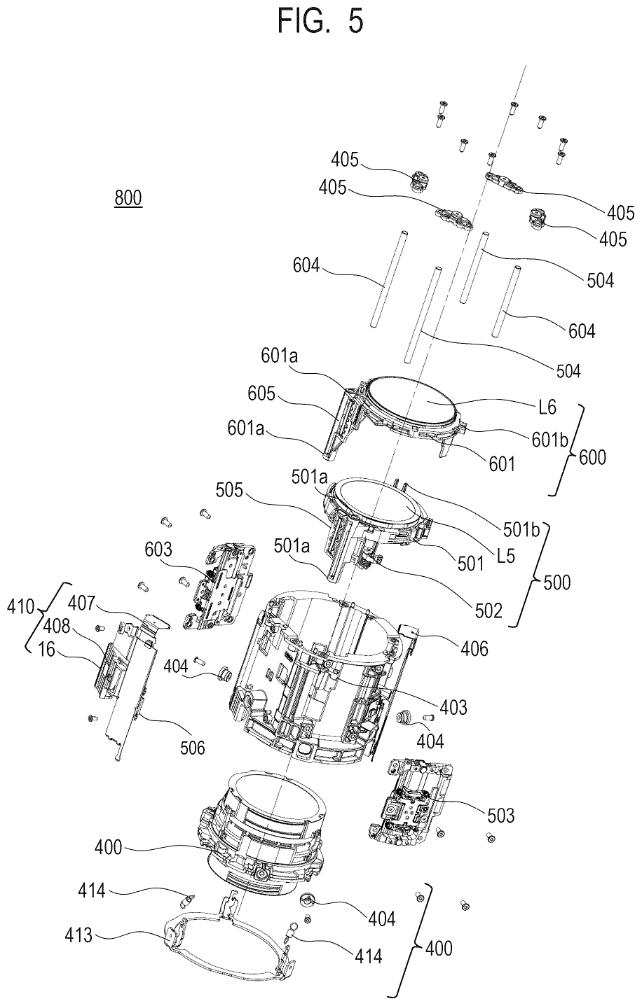

Next, each lens unit disposed in the guide barrel unit will be described with reference to FIGS. 1, 4, and 5. FIG. 4 is an exploded perspective view of each lens unit constituting the zoom mechanism. FIG. 5 is an exploded perspective view of a rear lens unit 800 to be described later.

The first lens unit 100 includes a first lens L1 and a first lens holding frame 101 that holds the first lens L1. The first lens holding frame 101 is provided with a first bayonet projection 101a (see FIG. 1), which is engaged with a first bayonet groove 9a of the guide barrel 9 to restrict movement in the optical axis direction, and the first lens holding frame 101 is radially fitted to and held by the distal end portion of the guide barrel 9 in the axial direction. The rotational direction of the first lens holding frame 101 is r restricted by a phase setting screw 102, and the first lens holding frame 101 does not move in the optical axis direction by the rotation of the zoom ring 6.

The second lens unit 200 includes a second lens L2, a second lens holding frame 201 that holds the second lens L2, a second base 202 (moving member), and the like. The second lens holding frame 201 is held by the second base 202 via a second eccentric roller 203. When the second eccentric roller 203 is rotated, the second lens holding frame 201 is held so as to fall with respect to the second base 202, and the second lens unit 200 is configured to be able to perform adjustment for recovering optical performance deterioration due to the tolerance of each component. Further, the second base 202 is moved by the cam locus having the largest cam intersection angle (standing) and has the largest amount of movement.

The second lens unit 200 holds a second main bearing 204 that engages with a second main straight groove 9d (see FIG. 3) provided in the guide barrel 9 and a second cam groove 10c provided in the cam ring 10. The second lens unit 200 holds a second biasing metal plate 206 and a second biasing spring 207. The second biasing metal plate 206 holds a second sub bearing 205 that engages with a second sub rectilinear groove 9g and the second cam groove 10c provided in the guide barrel 9. The second lens unit 200 and the second biasing metal plate 206 are pulled to each other by the second biasing spring 207, so that it is possible to suppress the backlash generated between the second main straight groove 9d, the second cam groove 10c, and the second main bearing 204.

With the above configuration, the second lens unit 200 can hold the second lens L2 with high accuracy and can move the position of the second lens L2 in the optical axis direction by the rotation of the cam ring 10.

The third lens unit 300 includes an aperture unit 12 (see FIG. 1) that adjusts the amount of light in the interchangeable lens 1 and three lens units. As illustrated in FIG. 1, a 3A lens unit 300A includes a 3A lens L3A and a 3A lens holding frame 301 that holds the 3A lens L3A and is held with respect to a 3B base 304 via a 3A eccentric roller 306. That is, when the 3A eccentric roller 306 is rotated in the third lens unit 300, the entire third lens unit 300 is decentered, so that it is possible to perform adjustment for recovering the deterioration of the optical performances due to the tolerances of the respective components.

In a 3B lens unit 300B, a 3B lens L3B and a 3B lens holding frame 302 that holds the 3B lens L3B are held so as to be movable in a direction orthogonal to the optical axis direction with respect to the 3B base 304. The 3B lens holding frame 302 is driven so as to correct the influence of camera shake using actuators such as voice coil motors. The 3B lens unit 300B is a so-called camera shake correction unit and is screwed and fixed to a 3C lens holding frame 303.

The aperture unit 12 is fixed to the 3B base 304 with screws. Actuators and the like of the aperture unit 12 and the camera shake correction unit are connected to the main substrate 11 via a third flexible printed substrate 308, and the main substrate 11 controls drive commands and the like of the actuators of the aperture unit 12 and the camera shake correction unit.

The 3C lens unit 300C includes a 3C lens L3C and the 3C lens holding frame 303 that holds the 3C lens L3C and is held with respect to a third base 305 (moving member) via a third eccentric roller 307. That is, when the third eccentric roller 307 is rotated in the third lens unit 300, the entire third lens unit 300 is inclined, so that it is possible to perform adjustment for recovering the deterioration of the of the optical performance due to the tolerances of the respective components.

The third lens unit 300 holds a third main bearing 309 that engages with a rear rectilinear groove 9e (rectilinear groove, see FIG. 3) provided in the guide barrel 9 and a third cam groove 10d provided in the cam ring 10. Note that a cam groove may be provided instead of the rear rectilinear groove 9e provided in the guide barrel 9.

A third biasing metal plate 311 and a third biasing spring 312 are held by the third lens unit 300. The third biasing metal plate 311 holds a third sub bearing 310 engaged with a third sub rectilinear groove 9h and the third cam groove 10d provided in the guide barrel 9. The third lens unit 300 and the third biasing metal plate 311 are pulled to each other by the third biasing spring 312, so that a backlash generated among the rear rectilinear groove 9e, the third cam groove 10d, and the third main bearing 309 is suppressed.

With the above configuration, the third lens unit 300 can hold the three lens units with high accuracy and can move the positions of the three lens units in the optical axis direction by the rotation of the cam ring 10.

As illustrated in FIG. 1, the fourth lens unit 400 includes a 4A lens unit 400A and a 4B lens unit 400B. The 4A lens unit 400A includes a 4A lens L4A and a 4A lens holding frame 401 configured to hold the 4A lens L4A, and the 4B lens unit 400B includes a 4B lens L4B and a 4B lens holding frame 402 configured to hold the 4B lens L4B. The 4A lens holding frame 401 is screwed and fixed to the 4B lens holding frame 402, and the fourth lens unit 400 is held via a fourth eccentric roller 404 with respect to the rear base 403 which moves in the optical axis direction. That is, in the fourth lens unit 400, when the fourth eccentric roller 404 is rotated, the fourth lens unit 400 is decentered with respect to the rear base 403, and thus it is possible to perform adjustment for recovering optical performance deterioration due to the tolerance of each component.

As illustrated in FIG. 5, the fifth lens unit 500 includes a fifth lens L5, a fifth lens holding frame 501 (sub moving member) that holds the fifth lens L5, and the like. Further, a fifth guide bar 504 is engaged with a fifth guide portion 501a and a fifth anti-vibration portion 501b of the fifth lens holding frame 501. One end of the fifth guide bar 504 is held by the rear base 403, the other end is held by a guide bar holder 405, and the guide bar holder 405 is fixed to the rear base 403 with screws. With this configuration, the fifth lens holding frame 501 is held so as to be relatively movable in the optical axis direction with respect to the rear base 403. The fifth lens unit 500 can be moved by receiving a driving force of a fifth linear ultrasonic motor 503 (driving unit), which is a vibration friction motor held by the rear base 403, via a fifth rack 502.

In addition, a scale 505 for detecting the position of a fifth unit is bonded and fixed to the fifth lens holding frame 501. A reflection pattern for detecting the position of the fifth lens holding frame 501 is provided on the surface of the scale 505 for detecting the position of the fifth unit. Further, a fifth position detection sensor 506 (second detection unit) provided with a light emitting unit and a light receiving unit can detect the relative position of the fifth lens holding frame 501 to the rear base 403 by detecting the reflection pattern. Note that the fifth lens unit 500 is a so-called focus unit that plays a role of a focusing function on the interchangeable lens 1 and has the highest focus sensitivity.

The sixth lens unit 600 includes a sixth lens L6, a sixth lens holding frame 601 (sub moving member) that holds the sixth lens L6, and the like. Further, a sixth guide bar 604 is engaged with a sixth guide portion 601a and a sixth anti-vibration portion 601b of the sixth lens holding frame 601. One end of the sixth guide bar 604 is held by the rear base 403, the other end thereof is held by the guide bar holder 405, and the guide bar holder 405 is fixed to the rear base 403 by screws. With this configuration, the sixth lens unit 600 is held so as to be relatively movable in the optical axis direction with respect to the rear base 403. The sixth lens unit 600 can be moved by receiving a driving force of a sixth linear ultrasonic motor 603 (driving unit), which is a vibration friction motor held by the rear base 403, via a sixth rack (not illustrated).

In addition, a scale 605 for detecting the position of a sixth unit is bonded and fixed to the sixth lens holding frame 601. A reflection pattern for detecting the position of the sixth lens holding frame 601 is provided on the surface of the scale 605 for detecting the position of the sixth unit. Further, an absolute position of the sixth lens holding frame 601 with respect to the rear base 403 can be detected by a sixth position detection sensor 606 provided with a light emitting portion and a light receiving portion. Note that the sixth lens unit 600 is a so-called floating unit that plays a role of aberration correction related to the optical axis direction in the interchangeable lens 1.

The fifth linear ultrasonic motor 503 and the sixth linear ultrasonic motor 603 are connected to a flexible printed substrate 406 for the drive unit. The flexible printed substrate 406 is connected to the main substrate 11, and a drive command is transmitted to the fifth linear ultrasonic motor 503 and the sixth linear ultrasonic motor 603 via the main substrate 11.

Note that the fifth position detection sensor 506 and the sixth position detection sensor 606 are connected to a flexible printed substrate 407 for sensing and are connected to the main substrate 11 via the flexible printed substrate 407 for sensing. The positions of the fifth lens unit 500 and the sixth lens unit 600 are feedback-controlled via the main substrate 11, and the positions are controlled based on commands from the main substrate 11.

The main substrate 11 is provided with a storage area for storing the positional relationship between the fifth lens unit 500 and the sixth lens unit 600 corresponding to the zoom position and the object distance. Then, by moving the fifth lens unit 500 and the sixth lens unit 600 based on the recognized zoom position information, control for suppressing defocus with respect to a subject at a predetermined distance is performed.

As illustrated in FIG. 4, the seventh lens unit 700 includes a seventh lens L7 and a seventh lens holding frame 701 (moving member) that holds the seventh lens L7. The seventh lens unit 700 holds a seventh roller 702 that engages with a rear rectilinear groove 9e provided in the guide barrel 9 and a seventh cam groove 10f provided in the cam ring 10. With this configuration, the position of the seventh lens unit 700 in the optical axis direction is moved by the rotation of the cam ring 10. The rear base 403 also holds the second base 202, the third base 305, and the seventh lens holding frame 701, which are a plurality of moving members having different movement loci, and the zoom position detection sensor 16 detects the positions of the moving members.

Although each lens unit has been described above, the fourth lens unit 400, the fifth lens unit 500, and the sixth lens unit 600 constitute the rear lens unit 800. The rear lens unit 800 holds a fourth main bearing 411 (engagement member, see FIG. 4) that engages with the rear rectilinear groove 9e provided in the guide barrel 9 and a rear cam groove 10e (cam groove, see FIG. 3) provided in the cam ring 10. Note that a straight groove may be provided instead of the rear cam groove 10e provided in the cam ring 10. Further, the rear lens unit 800 holds a fourth biasing metal plate 413 and a fourth biasing spring 414. With this configuration, the position of the rear base 403 of the fourth lens unit 400 in the optical axis direction is moved by the rotation of the cam ring 10. The rear base 403 moves in the optical axis direction on the inner diameter side of the guide barrel 9 and is a lens unit other than the lens unit of the first lens unit 100, which is a lens unit positioned closest to the object side, that is, the second lens unit 200 to the seventh lens unit 700.

The fourth biasing metal plate 413 holds the rear cam groove 10e and a fourth sub bearing 412 engaged with the rear cam groove 10e. Note that the rear cam groove 10e is a cam groove that is wide in the optical axis direction. The rear lens unit 800 and the fourth biasing metal plate 413 are pulled to each other by the fourth biasing spring 414, so that the backlash generated between the rear rectilinear groove 9e and the fourth main bearing 411 is shifted to one side. Further, the fourth main bearing 411 is biased against one surface of the wide rear cam groove 10e, and the fourth sub bearing 412 is biased against the other surface thereof. With this configuration, when the cam ring 10 rotates, the rear lens unit 800 can move its position in the optical axis direction while holding the rear lens unit 800 with high accuracy.

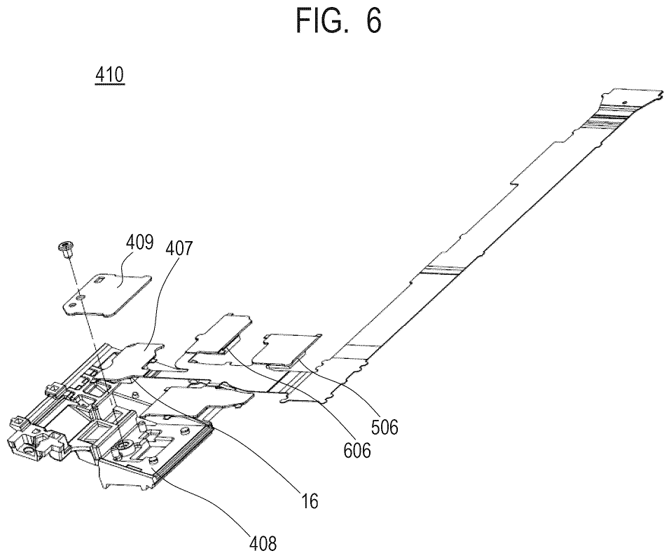

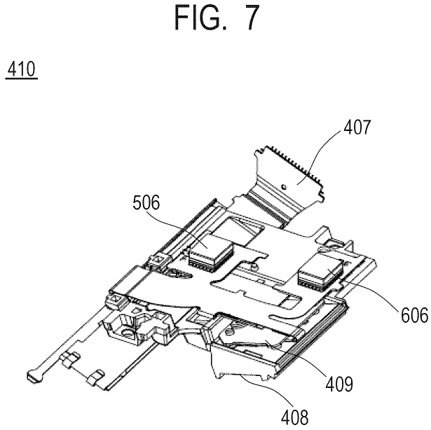

Next, a flexible substrate holder unit 410 will be described with reference to FIGS. 6 and 7. FIG. 6 is an exploded perspective view of the flexible substrate holder unit 410. FIG. 7 is a perspective view of the flexible substrate holder unit 410 after completion of assembly.

The flexible substrate holder unit 410 is a unit that holds the flexible printed substrate 407 on a flexible substrate holder 408. A fifth position detection sensor 506 and a sixth position detection sensor 606 for detecting the position of the fifth lens unit 500 and a zoom position detection sensor 16 for detecting the zoom position are mounted on the flexible printed substrate 407 for sensing.

Next, a method of holding the flexible printed substrate 407 on the flexible substrate holder 408 will be described. First, the back surface of the zoom position detection sensor 16 with respect to the flexible printed substrate 407 is positioned with respect to a flexible sheet metal 409 using a tool and is fixed using a double-sided tape. Thereafter, the flexible sheet metal 409 is fixed to the flexible substrate holder 408 with screws. Rear surface portions of the fifth position detection sensor 506 and the sixth position detection sensor 606 of the flexible printed substrate 407 are positioned with respect to the flexible substrate holder 408 by a tool and are fixed by using a double-sided tape.

The flexible substrate holder unit 410 is fixed to the rear base 403 with screws. By this holding method, each of the scale 505 for detecting the position of the fifth unit and the fifth position detection sensor 506, the scale 605 for detecting the position of the sixth unit and the sixth position detection sensor 606, and the zoom position detection scale 14 and the zoom position detection sensor 16 is held with desired facing accuracy.

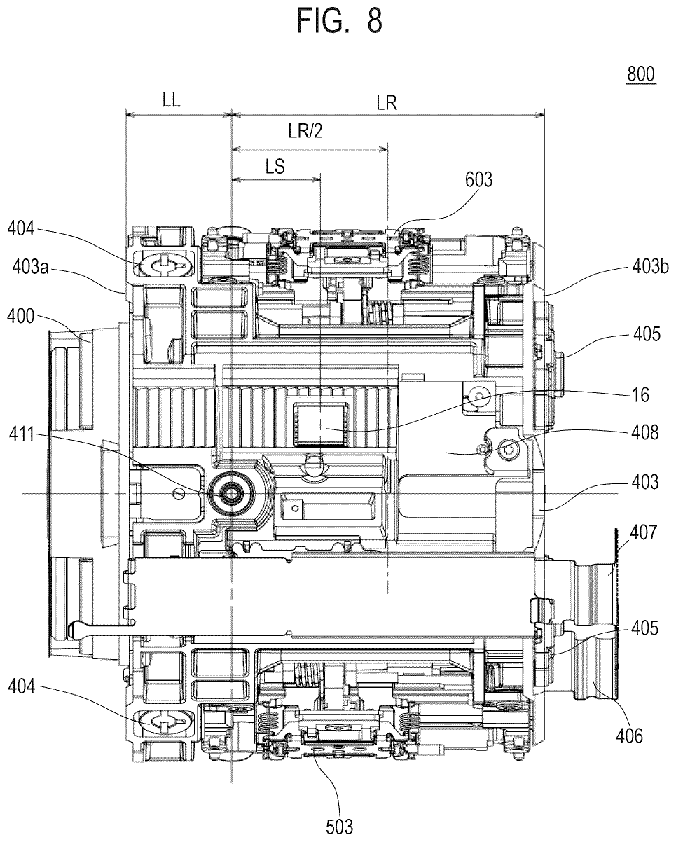

FIG. 8 is a top view of the rear lens unit 800 and illustrates the position of the zoom position detection sensor 16 in the optical axis direction in the rear lens unit 800. When viewed from the direction orthogonal to the optical axis direction, a distance from the holding position of the fourth main bearing 411 to the detection center position of the zoom position detection sensor 16 held by the rear base 403 is denoted by LS. Further, LL is a distance from the holding position of the fourth main bearing 411 to one end 403a of the rear base 403 on the near side, and LR is a distance from the holding position of the fourth main bearing 411 to the other end 403b of the rear base 403 on the far side. At this time, there is a LS≤LR/2, and the zoom position detection sensor 16 is held within this range. With such a configuration, since the zoom position detection sensor 16 can be disposed at a position close to the fourth main bearing 411 in the optical axis direction, it is possible to reduce a deviation in position detection.

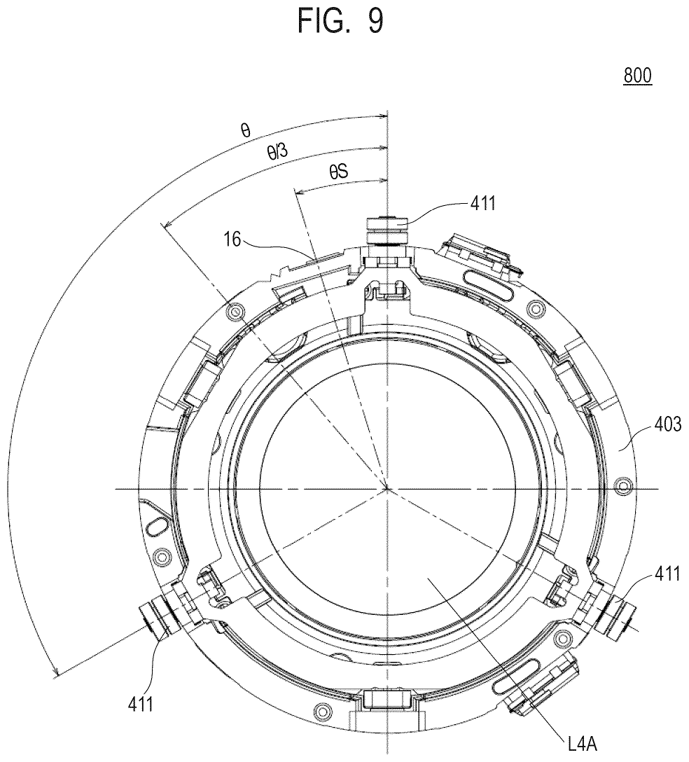

FIG. 9 is a side view of the rear lens unit 800 as viewed from the object side in the optical axis direction. When viewed from the optical axis direction, the closest angle from the holding position of the fourth main bearing 411 of the rear base 403 to the detection center position of the zoom position detection sensor 16 held by the rear base 403 is represented by θS. Further, when an angle between the holding positions of adjacent fourth main bearings 411 held by the rear base 403 is θ, a relationship of θS≤θ/3 is established with respect to any one of the fourth main bearings 411, and the zoom position detection sensor 16 is held within this range. With such a configuration, since the zoom position detection sensor 16 can be disposed at a position close to the fourth main bearing 411 in the circumferential direction of the optical axis direction, it is possible to reduce a deviation in position detection.

With the above configuration, it is possible to suppress the output fluctuation amount of the zoom position detection sensor 16 when the tilt fluctuation of the rear lens unit 800 occurs. Therefore, according to the embodiment, it is possible to provide an optical apparatus capable of suppressing the focus movement caused by the zoom change at the start of the zoom reversing operation.

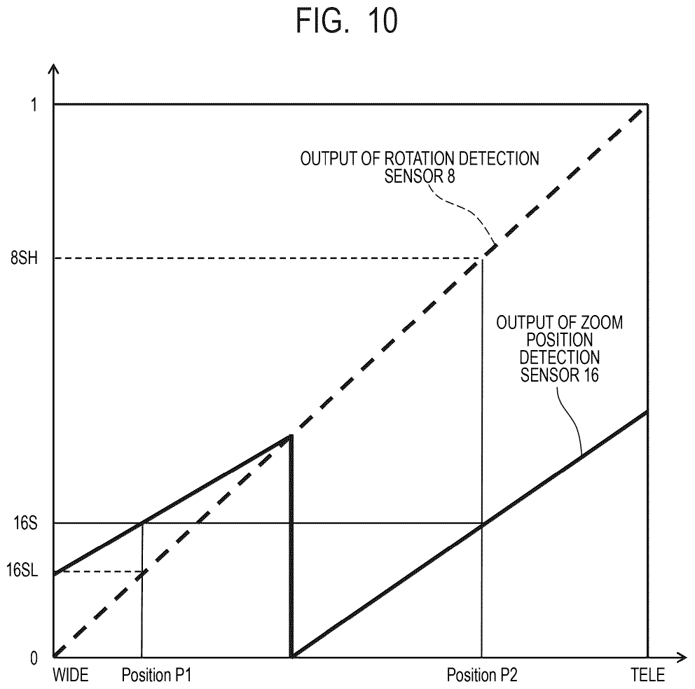

FIG. 10 is a diagram illustrating output characteristics of the rotation detection sensor 8 (broken line) of the zoom ring 6 and the zoom position detection sensor 16 (solid line). Each of the rotation detection sensor 8 and the zoom position detection sensor 16 can detect an absolute position corresponding to the zoom position.

The zoom position detection sensor 16 is a detector that detects an absolute position, but due to the detection pattern of the zoom position detection scale 14 of the embodiment, there are two positions where the zoom position and the output of the zoom position detection sensor 16 are the same output. For example, the outputs of the zoom position detection sensor 16 at the positions P1 and P2 in the diagram are both 16S. However, by combining the low-level sensor-output value 8SL and the high-level sensor-output value 8SH of the rotation detection sensor 8, it is possible to correctly detect whether the current zoom position is the position P1 or the position P2. By using this method, the embodiment can be applied to a slightly complicated cam locus.

In the zoom position detection according to the present disclosure, by detecting the output of the zoom position detection sensor 16 held by the rear lens unit 800, the relative position of the rear lens unit 800 with respect to the guide barrel 9 is converted into a zoom position and recognized. In this configuration, since the positional change of the lens unit is directly detected, the zoom position can be detected with less delay with respect to the change in the lens position, for example, as compared with the case where the zoom position is detected by the rotation detection sensor 8.

In the embodiment, the position of the rear lens unit 800 holding the fifth lens unit 500 (focus group) having high focus sensitivity is converted into the zoom position. In other words, the position of change of the lens unit having a large influence of the focus movement at the time of zooming is directly detected, and the fifth lens unit 500 can be used to change the focus position with little delay accordingly, making it possible to reduce focus movement that accompanies zoom changes.

In the embodiment, the configuration in which the position of the rear lens unit 800 including the fifth lens unit 500 having high focus sensitivity is detected has been described. However, the present disclosure is not limited thereto, and it is possible to select a group that is effective in suppressing focus movement at the time of a zoom reversal operation, such as a group with a large amount of movement or a group with a large (standing) cam intersection angle in the cam track.

### Application Example

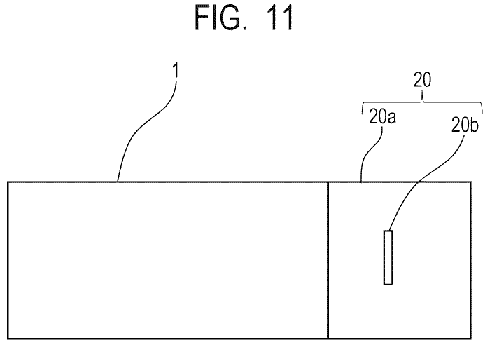

FIG. 11 is a schematic diagram illustrating a configuration example of a camera apparatus 20 (imaging apparatus) using the interchangeable lens 1 to which the present disclosure is applied. The imaging apparatus includes an interchangeable lens 1 and camera apparatus 20 including a camera body 20a having an image sensor 20b for capturing an image formed by the interchangeable lens 1. The imaging apparatus has a configuration in which the interchangeable lens 1 is detachably attached to the camera body 20a of the camera apparatus 20, but the camera body 20a and the interchangeable lens 1 may be integrally configured.

Although the preferred embodiments of the present disclosure have been described above, the present disclosure is not limited to these embodiments, and various modifications and changes can be made within the scope of the gist of the present disclosure.

While the embodiments of the present invention has been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-186883, filed Oct. 31, 2023, which is hereby incorporated by reference herein in its entirety.

What is claimed is:

1. An optical apparatus comprising:
a fixed member,
a base moving member that moves in an optical axis direction,
a rotating member rotatably held with respect to the fixed member, and
a detection unit configured to directly detect a relative position between the base moving member and the fixed member,
wherein the base moving member holds an engaging member that engages with one of a rectilinear groove and a cam groove provided in the fixed member and one of a cam groove and a rectilinear groove provided in the rotating member, and
wherein the base moving member moves in the optical axis direction by rotation of the rotating member.

2. The optical apparatus according to claim 1, wherein the base moving member holds at least one sub moving member held so as to be relatively movable in the optical axis direction with respect to the base moving member,
wherein the sub moving member is moved by a driving unit held by the base moving member.

3. The optical apparatus according to claim 1, wherein the base moving member moves in the optical axis direction on an inner diameter side with respect to the fixed member and holds a lens unit other than a lens unit positioned closest to the subject.

4. The optical apparatus according to claim 1, wherein the base moving member holds a plurality of moving members having different movement trajectories,
wherein the detection unit detects a position of any one of the moving members having a largest cam intersection angle, the moving member having the largest amount of movement, and the moving member having the highest focus sensitivity among the plurality of moving members.

5. The optical apparatus according to claim 1, wherein the detection unit includes a scale portion provided with a pattern and a detection portion configured to detect the pattern, and
wherein one of the scale portion and the detection portion is held by the fixed member, and the other of the scale portion and the detection portion is held by the base moving member.

6. The optical apparatus according to claim 5, wherein when viewed from a direction orthogonal to the optical axis direction, when a distance from a holding position of the engagement member of the base moving member to a detection center position of the detection portion held by the base moving member is LS, and a distance from the holding position of the engagement member to an end on a longer side of a distance from the holding position of the engagement member to an end portion of the base moving member is LR,
wherein the detection unit is held within a range of:
LS≤LR/2.

7. The optical apparatus according to claim 5, wherein when viewed from the optical axis direction, when an angle from a holding position of the engagement member of the base moving member to a detection center position of the detection portion held by the base moving member is θ S, and an angle between the adjacent engagement members held by the base moving member is θ, with respect to any one of the engagement members,
wherein the detection unit is held within a range of:
θS≤θ/3.

8. The optical apparatus according to claim 2, wherein the base moving member holds a second detector that detects a relative position of the sub moving member with respect to the base moving member.

9. An imaging apparatus comprising:
an optical apparatus and an image sensor configured to capture an image formed by the optical apparatus, the optical apparatus comprising:
a fixed member,
a base moving member that moves in an optical axis direction,
a rotating member rotatably held with respect to the fixed member,
a detection unit configured to directly detect a relative position between the base moving member and the fixed member,
wherein the base moving member holds an engagement member that engages with one of a rectilinear groove and a cam groove provided in the fixed member and one of a cam groove and a rectilinear groove provided in the rotating member, and
wherein the base moving member moves in the optical axis direction by rotation of the rotating member.
